(19) United States
(12) Patent Application Publication
(10) Pub. No.: US 2013/0044842 A1
(43) Pub. Date: Feb. 21, 2013

(54) RADIO-FREQUENCY FRONT ENDS WITH AUTOMATIC GAIN CONTROL

(71) Applicants: Dan Wang, Hong Kong (HK); Huimin Guo, Hong Kong (HK); Wai Po Wong, Hong Kong (HK); Weimin Zhang, Hong Kong (HK)

(72) Inventors: Dan Wang, Hong Kong (HK); Huimin Guo, Hong Kong (HK); Wai Po Wong, Hong Kong (HK); Weimin Zhang, Hong Kong (HK)

(73) Assignee: Hong Kong Applied Science and Technology Research Institute Company Limited, Hong Kong (HK)

(21) Appl. No.: 13/213,083

(22) Filed: Aug. 19, 2011

(51) Int. Cl. H04L 27/08

(52) U.S. Cl. 375/345

(57) ABSTRACT

A system for processing a wideband RF signal including at least an in-band signal and an out-of-band interference, comprising: an antenna; a low-noise amplifier (LNA), wherein gain of the LNA is variable and is controlled by a first gain-setting signal; a local oscillator for generating an oscillation signal at a first frequency that is spaced apart from the in-band signal carrier frequency by an intermediate frequency; a mixer for moving the in-band signal carrier frequency by the intermediate frequency and providing a variable conversion gain, which is controlled by a second gain-setting signal, to the in-band signal; a channel selection filter (CSF) for producing a desired-user signal; and an automatic gain control (AGC) unit for generating the first and second gain-setting signals derived from a desired LNA gain value, a desired mixer conversion gain value, strength of the in-band signal, and power of the out-of-band interference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to automatic gain control (AGC) for radio frequency (RF) receivers. Particularly, the present invention is related to improved gain setting for AGC in RF front ends by taking into consideration both the in-band signal strength and the out-of-band interference power in the gain computation.

### BACKGROUND

In a RF communication system that supports multiple users for communications, such as a cellular mobile communication system, the frequency band can be partitioned into a number of frequency channels and a user is assigned a channel for making communications. The RF receiver of a user is therefore required to process an in-band signal in the presence of out-of-band interference. The in-band signal, which is the signal intended for reception by this user, also referred to as a desired user, is a signal that the receiver desires to receive, demodulate, decode and process. The out-of-band interference is the sum of signal(s) originated from or intended to be received by users other than the desired user. Notice that the in-band signal is transmitted over the frequency channel assigned to the desired user while out-of-band signals for other users are transmitted on other frequency channels.

Although the RF receiver is only required to decode the signal on the frequency channel assigned to the desired user, there are practical reasons that the RF receiver is capable to tune to other frequency channels. First, the RF receiver is provided to the desired user by a supplier or a manufacturer. Mass production of RF receivers, thereby reducing production cost, is not possible if different RF receiver models are used for different frequency channels. A common practice is that a RF receiver model is manufactured to be able to tune to different frequency channels, and the desired user personalizes the RF receiver he or she acquires from the supplier. Second, the RF communication system may dynamically assign the frequency channels to the users. Dynamic channel assignment is commonly used in cellular mobile communication systems, for capacity optimization and provision of services with different quality requirements. In the presence of dynamic channel assignment, the frequency channel of the desired user varies from time to time. A receiver capable of tuning to different frequency channels is therefore required.

For a RF receiver capable of tuning to different channels over the frequency band of interest, the RF signal is first captured by an antenna with some RF filtering such that the received signal covers a bandwidth of at least the whole frequency band. The received signal is amplified by a low-noise amplifier (LNA), wherein the LNA contains some filtering arrangement in order to confine the amplified signal to have a bandwidth substantially covering the frequency band of interest. The amplified signal is then processed by a mixer, which is a nonlinear device functioning as a multiplier for multiplying the amplified signal and the signal from a local oscillator. The purpose of the mixer is to move the in-band signal (i.e., the desired-user signal) from a channel assigned to the desired user to a frequency segment with a certain fixed carrier frequency, commonly known in the art as an intermediate frequency. The mixer output is then filtered with a channel selection filter (CSF), which is a narrowband filter centered at the intermediate frequency. This filter is to extract the in-band signal in the presence of the out-of-band interference. The filter output is the desired-user signal for further signal processing.

An important component in a RF receiver is an AGC unit. Its main function is to adjust the gain of the LNA in order to prevent it from saturation in case the received signal is overly strong. Optionally, the AGC unit may also be used to adjust the gains of the mixer and of the CSF to prevent them from saturation. Saturation of the LNA/mixer/CSF introduces significant nonlinear distortion to their output signals, greatly degrading the receiver performance. The AGC unit computes the gain of the LNA/mixer/CSF based on one or more signal power levels observed along the signal-processing chain for the received signal. For instance, the gain can be computed based on the received signal strength measured at the LNA input, or the signal strength of the LNA output, or the strength of the mixer output, or the signal power at the CSF output. Algorithms to compute the gain can be found in references such as Smith, J., Modern Communication Circuits, 2^{nd} edition, McGraw-Hill, 1998 (referred to as Smith hereinafter), the disclosure of which is incorporated by reference herein in its entirety. Notice that the signals at the LNA input, the LNA output and the mixer output are wideband signals containing both the in-band signal and the out-of-band interference, whereas the CSF output contains the in-band signal only. Also notice that the in-band signal and the out-of-band interference are mutually uncorrelated, so that the out-of-band interference power cannot be estimated based on knowledge of the in-band signal strength. In the art, there are several methods of using the signal strength information in the realization of an AGC unit.

In U.S. Pat. No. 6,324,230, a realization of an AGC unit is disclosed, in which the gain of the LNA is computed based on the signal strength of the CSF output only. The AGC unit only keeps track of the strength of the in-band signal. In case the out-of-band interference is strong, the gain can be incorrectly determined so that saturation of the LNA and/or the mixer occurs. This condition leads to significant distortion of the desired-user signal, thereby significantly degrading the receiver performance.

In the disclosure of Huang, Y. T., A 1.2V 67 mW 4 mm² mobile ISDB-T tuner in 0.13 μm CMOS,” Proceedings of International Solid-State Circuits Conference (ISSCC), 2009, pages 124-125, the gain of the LNA is computed based on the signal strength of the mixer output. This signal contains both the in-band signal and the out-of-band interference. Computation of the gain based on such information ensures that saturation of the LNA is prevented. However, the AGC unit does not have knowledge of the in-band signal in the gain computation. The gain can be underestimated so that the desired-user signal has a lower than adequate signal strength. It results in a reduced signal-to-noise ratio, thereby degrading the receiver performance.

In U.S. Pat. No. 7,668,517, the AGC unit disclosed therein computes the gains for the LNA, the mixer and the CSF based on the signal strength of the LNA output. Similar to the disclosure in the previous reference, knowledge of the in-band signal is not available in the gain computation. Therefore, the gains can be underestimated and the desired-user signal strength can be lower than adequate, thereby degrading the receiver performance.

In U.S. Pat. No. 6,670,901, the AGC unit disclosed therein computes the gains for the LNA, the mixer and the CSF based on the signal strength at the LNA input, the mixer output signal strength and the signal power of the CSF output. With knowledge of both the in-band signal strength and the out-of-band interference power, the gains can be properly set to prevent saturation of the LNA/mixer/CSF as well as to produce a desired-user signal that has adequate power. The main disadvantage of this realization, however, is that a dedicated RF wideband power detector is required, thereby consuming additional power in operating the receiver and requiring additional die area in integrated circuits (ICs) used for such receiver.

There is a need for an improved AGC unit that fulfills the following requirements. First, the gain(s) are computed based on knowledge of both the in-band signal strength and the out-of-band interference power. Second, a RF wideband power detector is not required in the realization of the AGC unit.

### SUMMARY

The presently claimed invention includes a plurality of RF front ends each of which employs an improved AGC unit that fulfills the aforementioned two requirements. A RF front end, as defined herein, is a sub-system of a RF receiver that resides between the antenna and the first intermediate frequency stage. The improved AGC unit computes the gain of the LNA and that of the mixer based on knowledge of the in-band signal strength and the out-of-band interference power, wherein this knowledge is derived from the signal-power levels observed at the mixer output and at the CSF output. As a result, the gains can be correctly computed for preventing saturation of the LNA and the mixer. In addition, the desired-user signal, which is the CSF output, can be obtained with adequate signal power, thus maintaining a good signal-to-noise ratio, which is essential for good receiver performance. Another advantage of the presently claimed invention is that no RF wideband power detector is required. Elimination of the RF wideband power detector saves battery power in portable applications such as in mobile phones, and also reduces the required die size in the design of receiver ICs.

### BRIEF DESCRIPTION OF THE DRAWINGS

Embodiments of the invention are described in more detail hereinafter with reference to the drawings, in which

FIG. 1a shows a block diagram of an embodiment of a RF front end that employs an improved AGC unit;

FIG. 1b shows a block diagram of an embodiment of the improved AGC unit used in the RF front end;

FIG. 2 shows a block diagram of an embodiment of a first computation means used in the improved AGC unit of the RF front end, under the condition that a unity-gain filter is used for a CSF filter;

FIG. 3 shows a block diagram of an alternative embodiment of the RF front end that employs an improved AGC unit; and

FIG. 4 shows a circuit diagram of an embodiment of the improved AGC unit used in the RF front end.

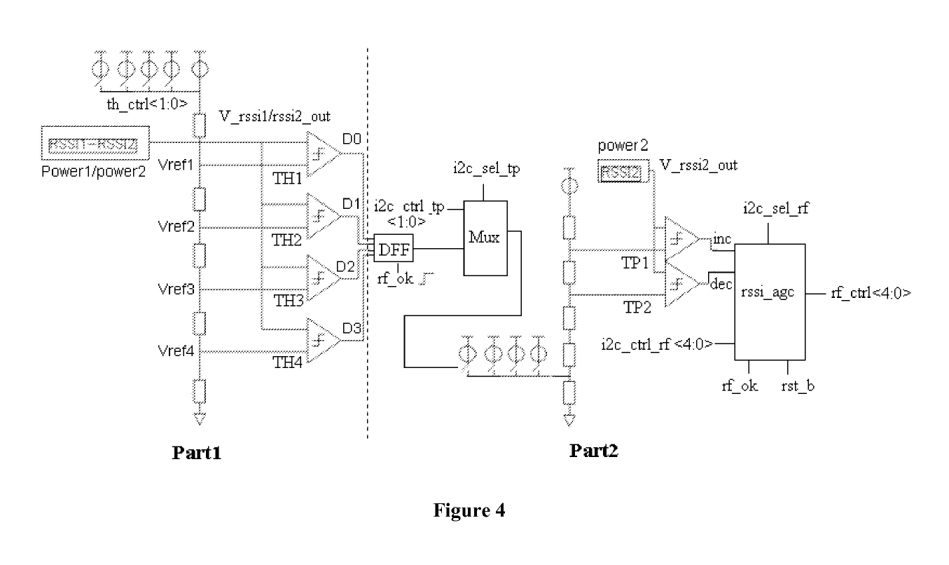

### DETAILED DESCRIPTION

In the following description, system and apparatus of RF front ends with AGC and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

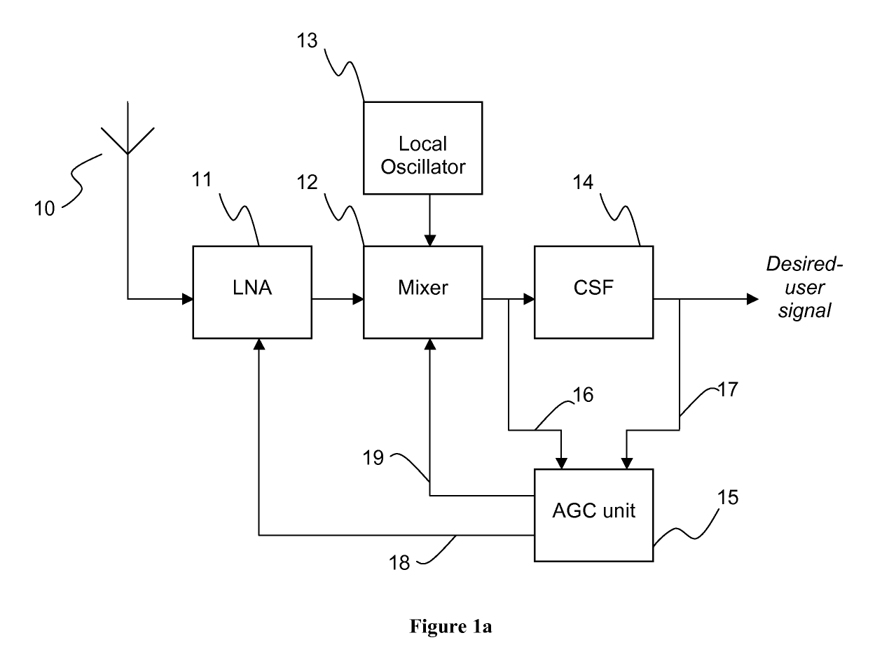

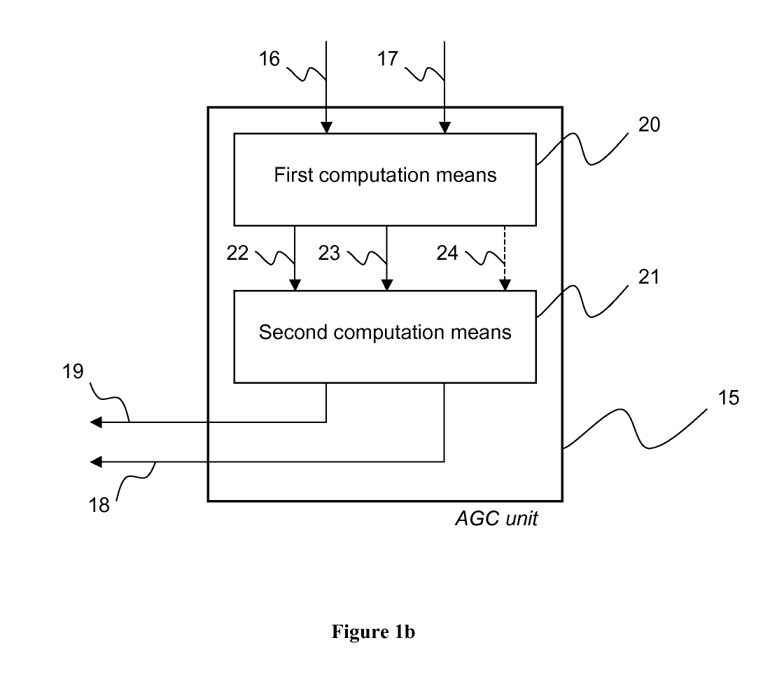

Referring to FIG. 1a, which shows an embodiment of a RF front end disclosed herein. The antenna 10 captures a RF signal that is a wideband signal comprising two signal components. One component is an in-band signal, which is the signal transmitted over the frequency channel that is assigned to a desired user. Another signal component is out-of-band interference. The wideband signal received by the antenna is fed to a LNA 11 for signal amplification. In this embodiment, the gain of the LNA 11 is variable and is controlled by a first gain-setting signal 18 issued from an improved AGC unit 15. The amplified signal is then fed to a first input of a mixer 12. A second input of the mixer 12 is connected to a local oscillator 13, which generates a free-running oscillation signal at a frequency that is either above or below the carrier frequency of the in-band signal by a spacing of an intermediate frequency. One option is that the intermediate frequency is zero Hz. In this case, the RF receiver is known as a direct-conversion receiver. The function of the mixer 12 is to move the in-band signal from its original carrier frequency to the intermediate frequency. The mixer 12 performs a frequency domain multiplication, which is a nonlinear operation, on the two inputs. This nonlinear operation generates a plurality of sum-frequency and difference-frequency signal components at the mixer output 16. The aforementioned setting of the frequency of the free-running oscillation signal is such that one difference-frequency signal component is the in-band signal moved to the intermediate frequency. The other signal components contribute to out-of-band interference that is frequency-shifted accordingly. Notice that the mixer output 16 comprises the in-band signal and the out-of-band interference, both of which are frequency-shifted. Apart from the moving of the in-band signal, the mixer 12 also provides at the mixer output 16 a power gain to the in-band signal component. This gain is known as a conversion gain. The conversion gain is variable and is controlled by a second gain-setting signal 19 issued from the AGC unit 15. The in-band signal component is then extracted from the mixer output 16 by a CSF 14. The CSF 14 is a narrowband filter centered at the intermediate frequency and with a passband equal to the bandwidth occupied by the in-band signal. The out-of-band interference is therefore rejected. It follows that the CSF output 17 contains only the in-band signal component without the out-of-band interference. The CSF output 17 is the desired-user signal and is the output of the disclosed RF front end. Electronic circuits for realization of the LNA 11, mixer 12, local oscillator 13 and CSF 14 can be found in Smith, incorporated by reference above.

For an AGC in the RF front end, the AGC unit 15 computes a desired gain for the LNA 11 and a desired conversion gain for the mixer 12 based on a mixer output 16 and a CSF output 17 as inputs. The desired gain for the LNA 11 is then communicated from the AGC unit 15 to the LNA 11 through the first gain-setting signal 18, in order to set the gain of the LNA 11. The desired conversion gain for the mixer 12 is also communicated from the AGC unit 15 to the mixer via the second gain-setting signal 19 for setting the conversion gain of the mixer 12. One distinguishing feature of the present disclosure is that the desired gain for the LNA 11 and the desired conversion gain for the mixer 12 are computed based on the in-band signal strength and the out-of-band interference power, both of which are in turn computed based on the mixer output 16 and the CSF output 17. Another distinguishing feature is that the AGC unit 15 does not require knowledge of the RF signal strength at the LNA input, eliminating the need for a RF wideband power detector. Computation of the in-band signal strength and the out-of-band interference power is elaborated as follows.

Since the CSF output 17 contains only the in-band signal component, the in-band signal strength can be computed from the CSF output 17 by a mathematical procedure realized in an electronic circuit in the AGC unit 15. One example of such procedure is squaring the amplitude of the CSF output 17 and averaging the squared values over a certain period of time, the average value being the in-band signal strength. The out-of-band interference power can also be computed from the signal power of the mixer output 16 and the signal power of the CSF output 17. Note that the signal power of the CSF output 17 is the in-band signal strength. Since the mixer output 16 comprises the in-band signal component and the out-of-band interference as mentioned in the above, and since this signal component and this interference are mutually uncorrelated, it follows that, if averaged over a sufficiently long time, the signal power of the mixer output 16 is, or statistically converges to, the sum of the in-band signal strength and the out-of-band interference power.

The signal power of the mixer output 16 can be computed by a mathematical procedure realized in an electronic circuit in the AGC unit 15. One example of such procedure is by squaring the amplitude of the mixer output 16 and taking an average value of the squared values over a certain period of time, the resultant average value being the signal power of the mixer output. In the case where the CSF 14 is providing neither a gain nor an attenuation to the in-band signal component in the CSF output 17, the in-band signal strength calculated from the CSF output 17 can be subtracted from the signal power of the mixer output 16 to obtain the out-of-band interference power. Otherwise, the in-band signal strength calculated from the CSF output 17 is required to be weighted accordingly to remove the gain/attenuation effect introduced by the CSF 14 before performing the subtraction. Based on the in-band signal strength and the out-of-band interference power, the desired gain for the LNA 11 and the desired conversion gain for the mixer 12 can be computed accordingly. Algorithms and electronic circuits for computing these two gains can be found in Smith.

Accordingly to various embodiments, the AGC unit 15 can be realized by a structure shown in FIG. 1b. The AGC unit 15 comprises a first computation means 20 and a second computation means 21. The first computation means 20 accepts the mixer output 16 and the CSF output 17 as inputs, and produces the in-band signal strength 22 and the out-of-band interference power 23 as outputs. Both the in-band signal strength 22 and the out-of-band interference power 23 are then fed to the second computation means 21. The second computation means 21 produces the desired gain for the LNA 11, which is sent out on the first gain-setting signal 18, and the desired conversion gain for the mixer 12, which is sent out on the second gain-setting signal 19. Optionally, the first computation means 20 sends a data-validity signal 24 to the second computation means 21 to signify that the in-band signal strength 22 and the out-of-band interference power 23 are valid data for the second computation means 21 to make calculation thereupon.

A simple implementation of the first computation means 20 can be achieved if the CSF 14 has an additional feature of a unity-gain filter providing a unity gain to the in-band signal component that passes the filter.

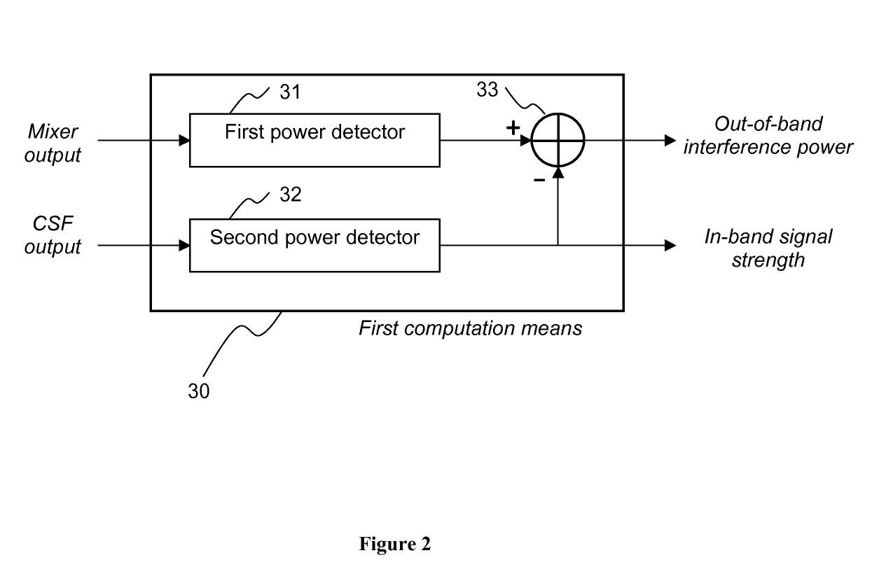

FIG. 2 shows a structure of a first computation means 30 realized under this unity-gain condition. The first computation means 30 comprises a first power detector 31, a second power detector 32, and a subtractor 33. The first power detector 31 accepts a mixer output as its input and estimates the signal power of the mixer output. An exemplary estimation procedure includes squaring the amplitude of the mixer output and taking an average value of the squared values over a certain period of time, with the resultant average value being the signal power of the mixer output.

The second power detector 32 accepts a CSF output as its input and estimates the signal power of the CSF output. An exemplary estimation procedure is by squaring the amplitude of the CSF output and averaging the squared values over a certain period of time, the average value being the signal power of the CSF output. The subtractor 33 is used to subtract the output of the first power detector 31 from the output of the second power detector 32, yielding an out-of-band interference power at the output of the subtractor 33. The output of the second power detector 32 indicates the in-band signal strength.

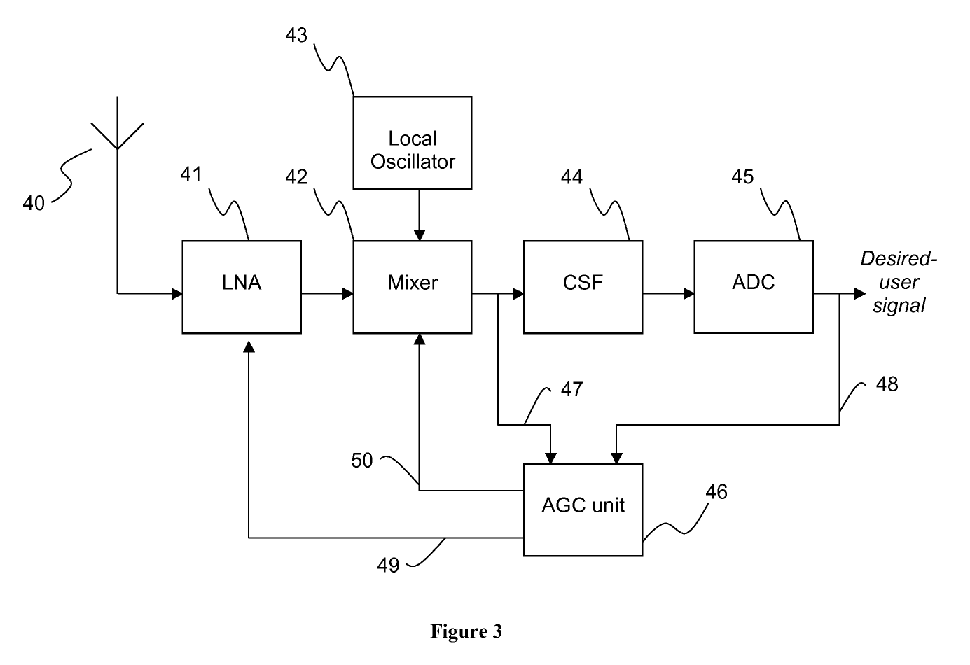

FIG. 3 shows an alternative embodiment of the RF front end. This embodiment is substantially similar to the previously described RF front end embodiment except that an analog-to-digital converter (ADC) 45 is included. An antenna 40 captures a wideband RF signal comprising two signal components that are an in-band signal and out-of-band interference. An LNA 41 is used to amplify the wideband RF signal received by the antenna 40. The gain of the LNA 41 is controlled by a first gain-setting signal 49. A mixer 42 is used to process the LNA output and the output of a local oscillator 43. The conversion gain of the mixer 42 is controlled by a second gain-setting signal 50. The mixer output 47 is fed to a CSF 44 for extracting the in-band signal component. The CSF output is fed to the ADC 45 for converting the CSF output originally in an analog form to an equivalent digital representation. The ADC output 48 provides a desired-user signal. An AGC unit 46 obtains the mixer output 47 and the ADC output 48 for computing the desired gain for the LNA 41, communicated to the LNA 41 through the first gain-setting signal 49; and the desired conversion gain for the mixer 42, communicated to the mixer 42 via the second gain-setting signal 50.

The antenna 40, LNA 41, mixer 42, local oscillator 43, CSF 44, and AGC unit 46 perform substantially similar functions as their counterparts 10, 11, 12, 13, 14, and 15, respectively, of the aforementioned disclosed RF front end embodiment as shown in FIG. 1a.

The AGC unit 46 can also be realized in a structure substantially similar to an AGC unit 15 shown in FIG. 1b, except that a CSF output 17 connected to the AGC unit 15 is replaced by an ADC output 48 for the AGC unit 46. The AGC unit 46 comprises a first computation means and a second computation means. In the case where the CSF 44 having an additional feature a unity-gain filter, the first computation means of the AGC unit 46 can be realized by a structure substantially similar to the first computation means 30 shown in FIG. 2, except that a CSF output connected to the first computation means 30 is replaced by the ADC output 48. Optionally, the intermediate frequency employed in this embodiment of the RF front end can be zero Hz.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for processing a wideband RF signal including at least an in-band signal and an out-of-band interference, comprising:
an antenna for receiving the wideband RF signal;
a low-noise amplifier (LNA) for amplifying the wideband RF signal received by the antenna, wherein the antenna has an electrical path to input of the LNA, and wherein gain of the LNA is variable and is controlled by a first gain-setting signal;
a local oscillator for generating an oscillation signal at a first frequency that is spaced apart, in frequency domain, from the in-band signal carrier frequency by an intermediate frequency;
a mixer for moving the in-band signal from its original carrier frequency to a carrier frequency equals to the intermediate frequency and providing a variable conversion gain to the in-band signal, wherein output of the LNA has an electrical path to input of the mixer and output of the local oscillator has an electrical path to input of the mixer, and wherein the variable conversion gain is controlled by a second gain-setting signal;
a channel selection filter (CSF) for extracting the in-band signal, rejecting the out-of-band interference, and producing a desired-user signal, wherein output of the mixer has an electrical path to input of the CSF; and
an automatic gain control (AGC) unit for generating the first gain-setting signal and the second gain-setting signal derived from a desired LNA gain value, a desired mixer conversion gain value, strength of the in-band signal, and power of the out-of-band interference, wherein measurements of the mixer output and the CSF output are used in computing the in-band signal strength, and the out-of-band interference power.

2. The system of claim 1, wherein the AGC unit generates the first gain-setting signal for controlling the LNA gain and the second gain-setting signal for controlling the mixer conversion gain according to a AGC computation based a desired LNA gain value and a desired mixer conversion gain value with feedback of the mixer output and the CSF output.

3. The system of claim 1, wherein the AGC unit comprises:
a first computation means for computing and generating the in-band signal strength and the out-of-band interference power based on the mixer output and the CSF output; and
a second computation means for computing and generating the first gain-setting signal and the second gain-setting signal based on a desired LNA gain value, a desired mixer conversion gain value, the in-band signal strength, and the out-of-band interference power.

4. The system of claim 3, wherein the first computation means comprises:
a first power detector for estimating the mixer output signal power;
a second power detector for estimating the CSF output signal power; and
a subtractor for subtracting the mixer output signal power from the CSF output signal power resulting the out-of-band interference power;
and wherein the CSF comprises a unity-gain filter.

5. The system of claim 4, wherein the first power detector estimates the mixer output signal power by determining squared value of each measurement of the mixer output signal amplitude measured over a period of time and taking an average value of the squared values over a certain duration of time, the average value being the mixer output signal power.

6. The system of claim 4, wherein the second power detector estimates the CSF output signal power by determining squared value of each measurement of the CSF output signal amplitude measured over a period of time and taking an average value of the squared values over a certain duration of time, the average value being the CSF output signal power.

7. The system of claim 3, wherein the AGC unit further comprises a data-validity signal sent from the first computation means to the second computation means.

8. The system of claim 1, wherein the CSF is a narrowband filter having a frequency domain response centered at the intermediate frequency with a passband equal to frequency bandwidth of the in-band signal.

9. The system of claim 1, wherein the intermediate frequency is zero Hz.

10. A system for processing a wideband RF signal including at least an in-band signal and an out-of-band interference, comprising:
an antenna for receiving the wideband RF signal;
a low-noise amplifier (LNA) for amplifying the wideband RF signal received by the antenna, wherein the antenna has an electrical path to input of the LNA, and wherein gain of the LNA is variable and is controlled by a first gain-setting signal;
a local oscillator for generating an oscillation signal at a first frequency that is spaced apart, in frequency domain, from the in-band signal carrier frequency by an intermediate frequency;
a mixer for moving the in-band signal from its original carrier frequency to a carrier frequency equals to the intermediate frequency and providing a variable conversion gain to the in-band signal, wherein output of the LNA has an electrical path to input of the mixer and output of the local oscillator has an electrical path to input of the mixer, and wherein the variable conversion gain is controlled by a second gain-setting signal;
a channel selection filter (CSF) for extracting the in-band signal, rejecting the out-of-band interference, and producing a desired-user signal, wherein output of the mixer has an electrical path to input of the CSF;
an analog-to-digital converter (ADC) for converting the desired user signal at output of the CSF from an analog form to an equivalent digital representation, wherein the CSF output has an electrical path to input of the ADC; and
an automatic gain control (AGC) unit for generating the first gain-setting signal and the second gain-setting signal derived from a desired LNA gain value, a desired mixer conversion gain value, strength of the in-band signal, and power of the out-of-band interference, wherein measurements of the mixer output and the ADC output are used in computing the in-band signal strength, and the out-of-band interference power.

11. The system of claim 10, wherein the AGC unit generates the first gain-setting signal for controlling the LNA gain and the second gain-setting signal for controlling the mixer conversion gain according to a AGC computation based a desired LNA gain value and a desired mixer conversion gain value with feedback of the mixer output and the ADC output.

12. The system of claim 10, wherein the AGC unit comprises:
a first computation means for computing and generating the in-band signal strength and the out-of-band interference power based on the mixer output and the ADC output; and
a second computation means for computing and generating the first gain-setting signal and the second gain-setting signal based on a desired LNA gain value, a desired mixer conversion gain value, the in-band signal strength, and the out-of-band interference power.

13. The system of claim 12, wherein the first computation means comprises:
a first power detector for estimating the mixer output signal power;
a second power detector for estimating the CSF output signal power; and
a subtractor for subtracting the mixer output signal power from the CSF output signal power resulting the out-of-band interference power;
and wherein the CSF comprises a unity-gain filter.

14. The system of claim 12, wherein the AGC unit further comprises a data-validity signal sent from the first computation means to the second computation means.

15. The system of claim 10, wherein the CSF is a narrowband filter having a frequency domain response centered at the intermediate frequency with a passband equal to frequency bandwidth of the in-band signal.

16. The system of claim 10, wherein the intermediate frequency is zero Hz.

17. A method for controlling a low-noise amplifier (LNA) gain and a mixer conversion gain in processing of a wideband RF signal including at least an in-band signal and an out-of-band interference, comprising:
determining output signal power of a mixer, comprising:
computing a squared value of each measurement of output signal amplitude of the mixer measured over a period of time, and
taking an average value of the squared values,
the average value being the mixer output signal power;
determining an in-band signal strength, comprising:
computing a squared value of each measurement of output signal amplitude of a channel selection filter (C SF) measured over a period of time, and
taking an average value of the squared values,
the average value being output signal power of the CSF,
the in-band signal strength being the CSF output signal power;
determining an out-of-band interference power by subtracting the mixer output signal power from the in-band signal strength;
deriving from a desired LNA gain value, a desired mixer conversion gain value, the in-band signal strength, and the out-of-band interference power to generate a first gain-setting signal for controlling the LNA gain and a second gain-setting signal for controlling the mixer conversion gain.
